(19) United States
(12) Patent Application Publication
(10) Pub. No.: US 2025/0254419 A1
(43) Pub. Date: Aug. 7, 2025

(54) CONTROL APPARATUS AND IMAGE CAPTURE APPARATUS

(71) Applicant: CANON KABUSHIKI KAISHA, Tokyo (JP)

(72) Inventor: NORIAKI SATO, Tokyo (JP)

(21) Appl. No.: 19/021,811

(22) Filed: Jan. 15, 2025

(30) Foreign Application Priority Data
Feb. 2, 2024 (JP) 2024-015048

(51) Int. Cl. H04N 23/661; H04N 23/63

(52) U.S. Cl. CPC H04N 23/661; H04N 23/632

(57) ABSTRACT

A control apparatus includes a communication unit that communicates with an image capture apparatus, a transmission unit that transmits a control instruction to the image capture apparatus, a reception unit that receives, from the image capture apparatus, a second image in which data amount is smaller than that of a first image shot by the image capture apparatus, a display unit that displays a list of the second images received from the image capture apparatus, and a control unit that notifies the image capture apparatus of the second image selected from the list.

### BACKGROUND OF THE INVENTION

### Field of the Invention

The present invention relates to a system in which a control apparatus controls an image capture apparatus.

### Description of the Related Art

A system is known in which a plurality of image capture apparatuses and a control apparatus are connected via a network, and the control apparatus remotely controls the plurality of image capture apparatuses. In such a system, a large amount of data such as a live view image transmitted from the image capture apparatus to the control apparatus, a control instruction transmitted from the control apparatus to the image capture apparatus, and image data transferred from the image capture apparatus to the server are exchanged, and measures to prevent a communication band from being compressed are required.

As one of such measures, Japanese Patent Laid-Open No. 2018-137725 describes a technique of displaying a list of images stored in an image capture apparatus and preferentially transferring an image selected by a user to a server.

However, in Japanese Patent Laid-Open No. 2018-137725, in order to enable the control apparatus to browse and select the image stored in the image capture apparatus, the control apparatus needs to acquire the image stored in the image capture apparatus from the image capture apparatus, and a communication band is compressed.

### SUMMARY OF THE INVENTION

The present invention has been made in consideration of the aforementioned problems, and realizes techniques for reducing the amount of communication data between an image capture apparatus and a control apparatus.

In order to solve the aforementioned problems, the present invention provides a control apparatus comprising: a communication unit that communicates with an image capture apparatus; a transmission unit that transmits a control instruction to the image capture apparatus; a reception unit that receives, from the image capture apparatus, a second image in which data amount is smaller than that of a first image shot by the image capture apparatus; a display unit that displays a list of the second images received from the image capture apparatus; and a control unit that notifies the image capture apparatus of the second image selected from the list.

In order to solve the aforementioned problems, the present invention provides an image capture apparatus comprising: a communication unit that communicates with a control apparatus; a reception unit that receives a control instruction from the control apparatus; a transmission unit that transmits, to the control apparatus, a second image in which a data amount is smaller than that of a first image shot by the image capture apparatus; a storage unit that stores the first image shot in response to the control instruction; and a control unit that executes, in response to receiving a notification of the second image from the control apparatus, a predetermined processing related to the first image associated with the notified second image.

In order to solve the aforementioned problems, the present invention provides a control method of a control apparatus comprising: connecting with an image capture apparatus so as to be capable of mutual communication; transmitting a control instruction to the image capture apparatus; receiving, from the image capture apparatus, a second image in which data amount smaller than that of a first image shot by the image capture apparatus; displaying a list of the second images received from the image capture apparatus; and notifying the image capture apparatus of the second image selected from the list.

In order to solve the aforementioned problems, the present invention provides a control method of an image capture apparatus comprising: connecting with a control apparatus so as to be capable of mutual communication; receiving a control indication from the control apparatus; transmitting, to the control apparatus, a second image in which data amount smaller than that of a first image shot by the image capture apparatus; storing the first image shot in response to the control instruction; and executing, in response to receiving a notification of the second image from the control apparatus. a predetermined processing related to the first image associated with the notified second image.

According to the present invention, the amount of communication data between the image capture apparatus and the control apparatus can be reduced.

Further features of the present invention will become apparent from the following description of exemplary embodiments (with reference to the attached drawings).

### BRIEF DESCRIPTION OF THE DRAWINGS

FIG. 1 is a diagram illustrating a system configuration according to a present embodiment.

FIG. 2 is a block diagram illustrating a configuration of an image capture apparatus according to the present embodiment.

FIG. 3 is a block diagram illustrating a configuration of a control apparatus and an image management apparatus according to the present embodiment.

FIG. 4 is a flowchart illustrating control processing of the control apparatus according to a first embodiment.

FIG. 5 is a flowchart illustrating control processing of the image capture apparatus according to the first embodiment.

FIGS. 6A and 6B are diagrams illustrating a list of image files stored in the control apparatus and the image capture apparatus according to the first embodiment.

FIG. 7 is a flowchart illustrating control processing of a control apparatus according to a second embodiment.

FIG. 8 is a flowchart illustrating control processing of the image capture apparatus according to the second embodiment.

FIG. 9 is a flowchart illustrating control processing of a control apparatus according to a third embodiment.

FIG. 10 is a flowchart illustrating control processing of the image capture apparatus according to a third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

In the present embodiment, an example in which the image capture apparatus of the present invention is applied to a digital camera, the control apparatus is applied to a personal computer (desktop PC, notebook PC, tablet PC, etc.), and the image management apparatus is applied to a server computer will be described. Note that the image capture apparatus of the present embodiment is not limited to a digital camera, and can be applied to any apparatus that has a camera function and a communication function. In addition, the control apparatus of the present embodiment can be applied to any apparatus that has a communication function and a display function.

### System Configuration

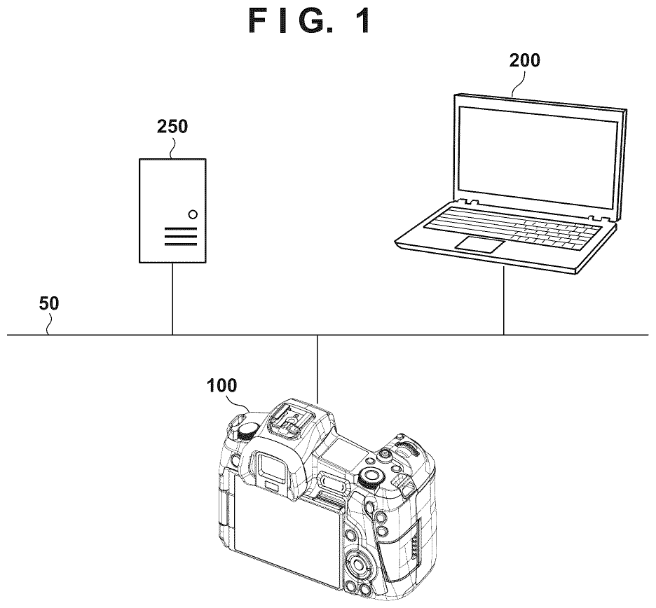

First, a system configuration of the present embodiment will be described with reference to FIG. 1.

In the system according to the present embodiment, the image capture apparatus 100, the control apparatus 200, and the image management apparatus 250 are connected via a network 50, and respective IP addresses and the like are registered in the image capture apparatus 100, the control apparatus 200, and the image management apparatus 250, and can communicate with each other. Note that in the present embodiment, one image capture apparatus 100 is provided, but a plurality of image capture apparatuses 100 may be provided.

The image capture apparatus 100 is controlled by a control instruction received from the control apparatus 200. The image capture apparatus 100 stores the original image (first image) captured according to the shooting instruction of the control apparatus 200, and transmits a live view image or a thumbnail image (second image) of the original image immediately before or immediately after the shooting instruction to the control apparatus 200 instead of the original image. As described above, in the present embodiment, the amount of communication data in the network 50 can be reduced, and the live view image or the original image associated with the original image stored by the image capture apparatus 100 can be browsed or selected in the control apparatus 200. The image capture apparatus 100 transfers an image selected as a transfer target by the control apparatus 200 among the original images to the image management apparatus 250.

The control apparatus 200 can remotely control the image capture apparatus 100 by transmitting a control instruction to the image capture apparatus 100. The control apparatus 200 transmits a shooting instruction to the image capture apparatus 100, and receives and stores a live view image or a thumbnail image associated with the original image shot in accordance with the shooting instruction from the image capture apparatus 100. Furthermore, the control apparatus 200 selects an image of transfer target to be preferentially transferred to the image management apparatus 250 from the original images shot by the image capture apparatus 100, and notifies the image capture apparatus 100 of the transfer target.

The image capture apparatus 100 transfers an image selected as a transfer target by the control apparatus 200 among the original images to the image management apparatus 250 in preference to other original images.

In the present embodiment, the first image is an original image, the second image is a live view image or a thumbnail image associated with the original image, and the image includes a moving image or a still image.

The image management apparatus 250 can store the original image transferred from the image capture apparatus 100.

In the present embodiment, the image management apparatus 250 is an FTP server that transmits and receives files to and from an FTP client in accordance with a file transfer protocol (FTP). The image capture apparatus 100 is connected to the FTP server as an FTP client so as to be capable of mutual communication. Note that the communication protocol of the present embodiment is not limited to FTP, and may be file transfer protocol over SSL/TLS (FTPS), SSH file transfer protocol (SFTP), or the like.

The network 50 is a communication path that connects at least one image capture apparatus 100, the control apparatus 200, and the image management apparatus 250 by a wireless antenna or a wired cable so as to be capable of mutual communication.

### Apparatus Configuration

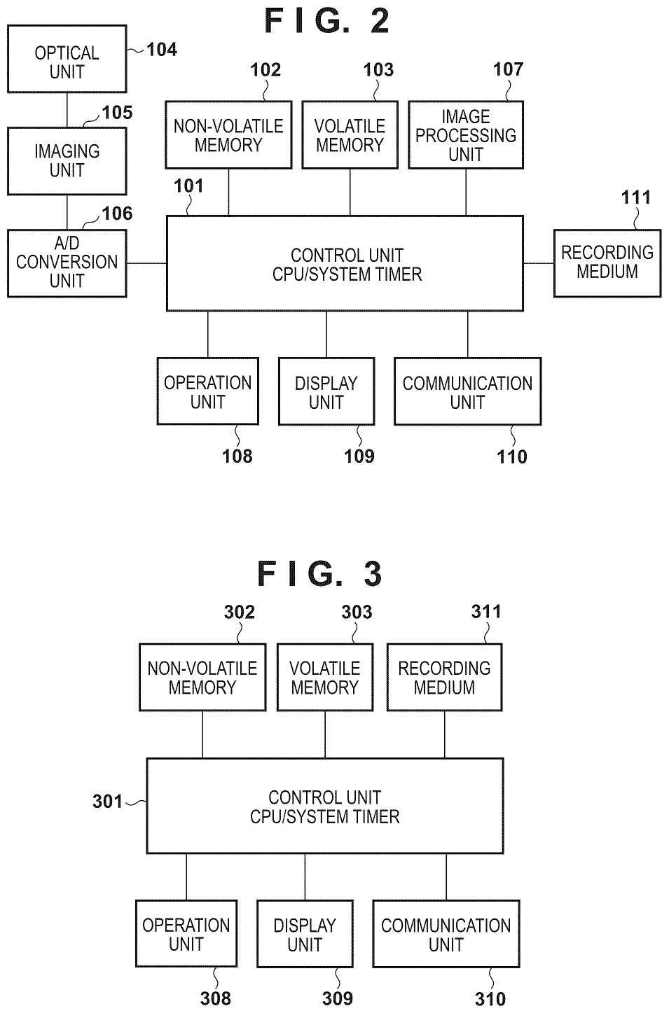

Next, a configuration and a function of the image capture apparatus 100 of the present embodiment will be described with reference to FIG. 2.

FIG. 2 is a block diagram illustrating a configuration of the image capture apparatus 100 of the present embodiment.

The image capture apparatus 100 includes a control unit 101, a non-volatile memory 102, a volatile memory 103, an optical unit 104, an imaging unit 105, an A/D conversion unit 106, an image processing unit 107, an operation unit 108, a display unit 109, a communication unit 110, and a recording medium 111.

The control unit 101 is an arithmetic processing processor (CPU or MPU) that totally controls the entire image capture apparatus 100, and controls components to be described later by executing a control program stored in the non-volatile memory 102. Furthermore, the control unit 101 controls the image capture apparatus 100 based on the control instruction received from the control apparatus 200. The control instruction includes a shooting instruction of an image and a file operation instruction to be described later. Note that, instead of the control unit 101 controlling the entire apparatus, controlling the entire apparatus may be performed by a plurality of units of hardware sharing the processing.

The control unit 101 includes a system timer that measures a time used for various types of control and a time of a built-in clock.

The non-volatile memory 102 is a ROM and is used as a storage area that stores constants, programs, and the like for operation of the control unit 101. The program is a program for executing control processing described later.

The volatile memory 103 is a RAM, and is used as a work area for developing constants and variables for operation of the control unit 101, programs read from the non-volatile memory 102, and the like. In addition, the volatile memory 103 is also used as a buffer memory that temporarily saves image data and the like captured by the imaging unit 105 described late.

The optical unit 104 includes a lens group including a zoom lens or a focus lens, and a shutter having a diaphragm function

The imaging unit 105 includes an image sensor including a CCD, a CMOS, or the like that converts the optical image of the subject formed by the optical unit 104 into an electrical signal. The imaging unit 105 generates still image data and moving image data formed of an analog signal.

The A/D conversion unit 106 converts the analog signal generated by the imaging unit 105 into a digital signal. The A/D conversion unit 106 generates still image data or moving image data formed of a digital signal from still image data or moving image data formed of an analog signal.

The image processing unit 107 executes various types of image processing on the image data output from the A/D conversion unit 106. Furthermore, the image processing unit 107 compression-encodes still image data subjected to image processing in a JPEG format or the like, or encodes moving image data in a moving image compression scheme such as an MP4 format to generate an image file (original image), and records the image file in the recording medium 111. Furthermore, the image processing unit 107 decrypts a still image file read from the recording medium 111, and decodes a moving image file read from the recording medium 111.

Furthermore, the image processing unit 107 generates a live view image from the image data output from the A/D conversion unit 106, and generates a thumbnail image from the image data subjected to the image processing. The live view image and the thumbnail image are images in which the data amount is reduced and the size (width, height) is reduced as compared with the original image.

Furthermore, the control unit 101 performs AE processing and AF processing by controlling the optical unit 104 based on a result of performing predetermined arithmetic processing using the image data subjected to image processing.

The operation unit 108 is an operation member such as a switch, a button, or a touch panel that accepts various operations from a user, and notifies the control unit 101 of the operations. The operation unit 108 includes at least a still image shooting button, a moving image shooting button, a mode dial, and a power switch

The still image shooting button is an operation member for instructing the control unit 101 to perform shooting processing of a still image. The moving image shooting button is an operation member for instructing the control unit 101 to perform shooting processing of a moving image.

The mode dial is an operation member for switching an operation mode of the image capture apparatus 100. The mode dial can switch the operation mode of the image capture apparatus 100 to any of a still image shooting mode, a moving image shooting mode, and a reproduction mode.

The power switch is an operation member for switching on/off of the power of the image capture apparatus 100.

When the still image shooting button is half-pressed, the control unit 101 is notified of an instruction of shooting preparation processing. In the still image shooting mode, when the still image shooting button is half-pressed, the control unit 101 starts the shooting preparation processing (AE processing and AF processing) of a still image When the still image shooting button is fully pressed, the control unit 101 is notified of an instruction of shooting processing When the still image shooting button is fully pressed, the control unit 101 executes still image shooting processing of recording the image data captured by the imaging unit 105 on the recording medium 111. Note that the shooting preparation processing is not limited to the case where the still image shooting button is half-pressed, and there is also a case where at least one of the AE processing and the AF processing is executed by operating an operation member for AE or an operation member for AF different from the still image shooting button included in the operation unit 108.

Furthermore, in the moving image shooting mode, the control unit 101 performs the shooting preparation processing (AE processing and AF processing) on the image data (frame) captured by the imaging unit 105 in response to the moving image shooting button being pressed first, continues the moving image shooting processing of recording a moving image for a predetermined time on the recording medium 111, and stops the moving image shooting processing in response to the moving image shooting button being pressed again.

The display unit 109 displays image data (live view image) captured by the imaging unit 105, displays image data read from the recording medium 111, displays a graphical user interface (GUI) for interactive operation, and the like The display unit 109 includes, for example, a display device such as a liquid crystal display or an organic EL display.

The communication unit 110 is connected to an external apparatus by a wireless antenna or a wired cable so as to be capable of mutual communication, and transmits and receives various types of information. The communication unit 110 can also be connected to a wireless local area network (LAN) or the Internet The various types of information include a live view image and a thumbnail image transmitted from the image capture apparatus 100 to the control apparatus 200, a control instruction transmitted from the control apparatus 200 to the image capture apparatus 100, and the like.

The recording medium 111 is a memory card, a hard disk, or the like, and records an image file or the like generated by the image processing unit 107. The control unit 101 reads data from the recording medium 111 and writes data to the recording medium 111.

Note that the control unit 101 can execute the still image shooting processing and the moving image shooting processing according to the shooting instruction received from the control apparatus 200. Furthermore, the control unit 101 can perform file operation of a still image or a moving image according to a file operation instruction received from the control apparatus 200. When the file operation instruction is a priority transfer instruction of an image, the still image recorded by the still image shooting processing and the moving image recorded by the moving image shooting processing can be transferred to the image management apparatus 250.

Note that the image capture apparatus 100 may not necessarily include the operation unit 108 or the display unit 109 as long as it can be remotely controlled by the control apparatus 200.

Next, configurations and functions of the control apparatus 200 and the image management apparatus 250 according to the present embodiment will be described with reference to FIG. 3.

The control apparatus 200 and the image management apparatus 250 include a control unit 301, a non-volatile memory 302, a volatile memory 303, an operation unit 308, a display unit 309, a communication unit 310, and a recording medium 311.

The control unit 301 includes a processor (CPU) that performs arithmetic processing and control processing of the control apparatus 200 and the image management apparatus 250, and controls each component of the control apparatus 200 and the image management apparatus 250 by executing a control program stored in the non-volatile memory 302.

The control unit 301 includes a system timer that measures a time used for various types of control and a time of a built-in clock.

The volatile memory 303 is a main storage device such as a RAM. The volatile memory 303 is loaded with constants and variables for operation of the control unit 301, a control program read from the non-volatile memory 302, and the like. In addition, the volatile memory 303 stores the image data received from the image capture apparatus 100 by the communication unit 310. The volatile memory 303 has a sufficient storage capacity to hold these pieces of information.

The non-volatile memory 302 is an auxiliary storage device such as an EEPROM, a flash memory, a hard disk drive (HDD), a solid state drive (SSD), or a memory card. The non-volatile memory 302 stores an operating system (OS) which is basic software executed by the control unit 301, a control program including an application that realizes an application function in cooperation with the OS, and the like.

The communication unit 310 is an interface (I/F) conforming to a wired communication standard such as Ethernet (registered trademark) or an interface conforming to a wireless communication standard such as Wi-Fi (registered trademark). The communication unit 310 is connected to the image capture apparatus 100 via a network 50 such as a wired LAN or a wireless LAN, and can transmit and receive data. The control unit 301 realizes communication with an external apparatus by controlling the communication unit 310. Note that the communication scheme is not limited to Ethernet (registered trademark) or Wi-Fi (registered trademark), and a communication standard such as IEEE 1394 may be used.

The operation unit 308 is an operation member such as a switch, a button, or a touch panel that accepts various types of operations of a user, and outputs operation information to the control unit 301. In addition, the operation unit 308 provides a user interface for the user to operate the control apparatus 200 and the image management apparatus 250.

The display unit 309 displays an image received from the image capture apparatus 100, displays a GUI for interactive operation, and the like. The display unit 309 is a display device such as a liquid crystal display or an organic EL display. The display unit 309 may be integrated with the control apparatus 200 or the image management apparatus 250, or may be an external apparatus connected to the control apparatus 200 or the image management apparatus 250.

As will be described later, the control apparatus 200 displays a list of live view images and thumbnail images received from the image capture apparatus 100 and stored on the display unit 309 so that the user can browse the list, and the user can select an image from the list via the operation unit 308.

Note that the image management apparatus 250 may not necessarily include the operation unit 308 or the display unit 309 as long as it can store the image transferred from the image capture apparatus 100.

### Control Processing

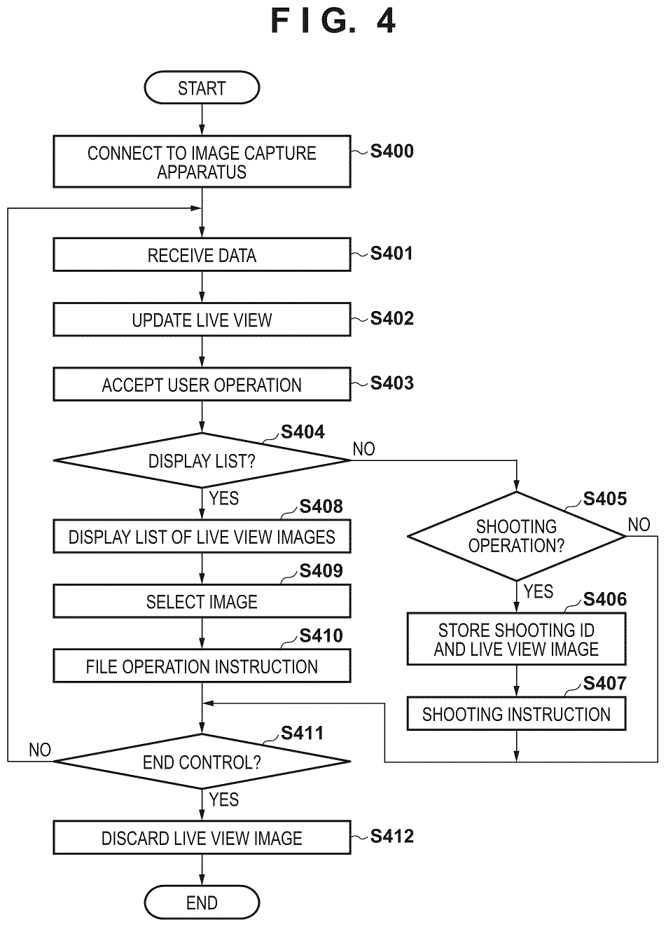

Next, control processing of the image capture apparatus 100 and the control apparatus 200 according to the first embodiment will be described with reference to FIGS. 4 to 6B.

FIG. 4 is a flowchart illustrating control processing of the control apparatus 200 of the first embodiment.

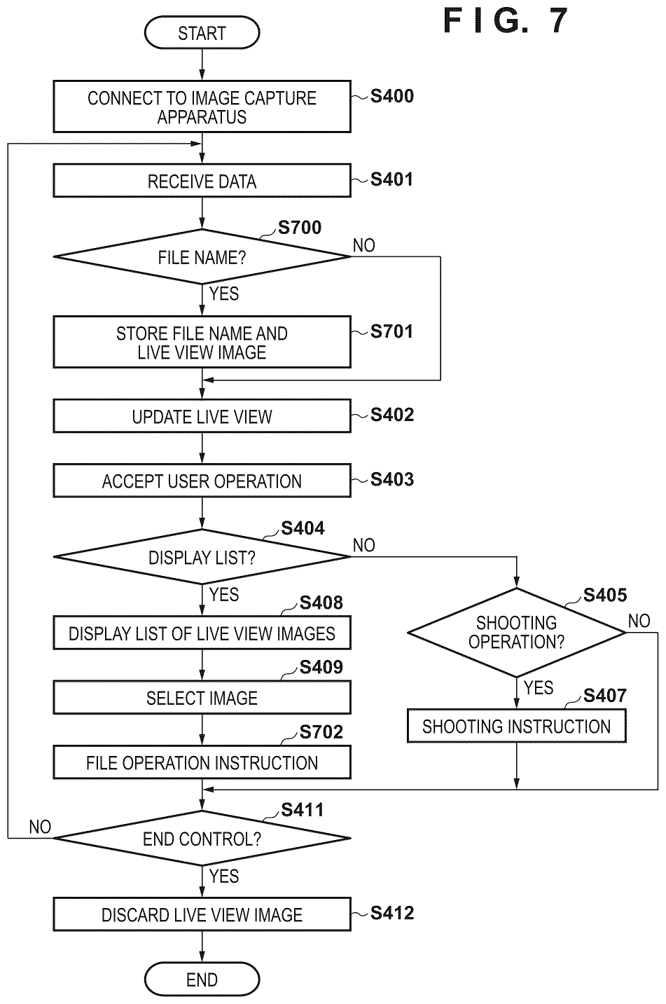

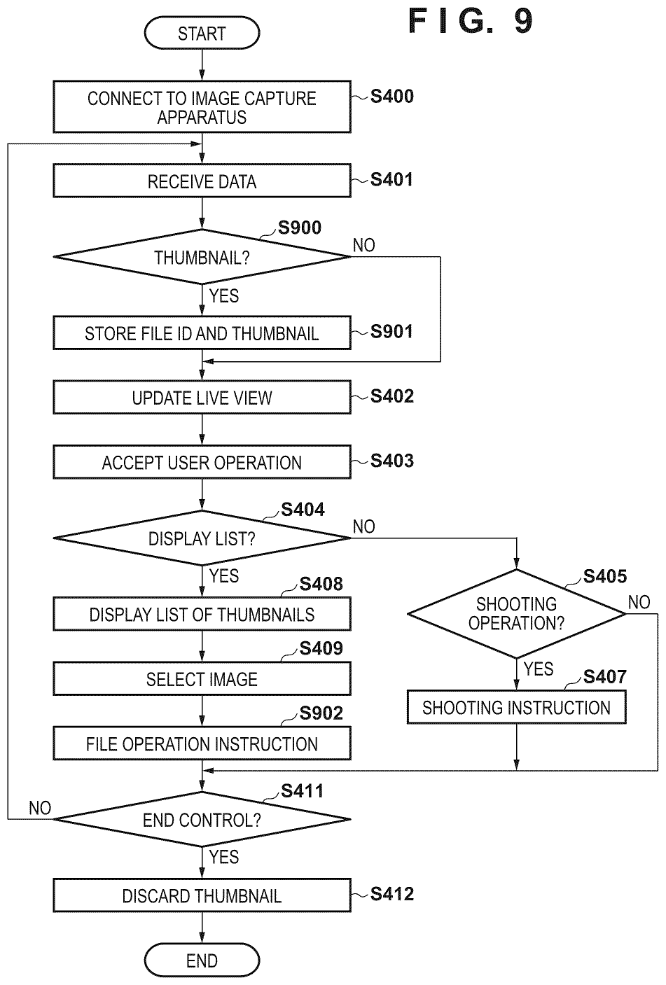

The processing of FIG. 4 is realized by the control unit 301 loading a program stored in the non-volatile memory 302 into the volatile memory 303 and executing the program to control each component of the control apparatus 200. The same applies to FIGS. 7 and 9 described later.

In the first embodiment, in a case where a live view image sequentially transmitted from the image capture apparatus 100 is displayed on the display unit 309, the control apparatus 200 receives, from the image capture apparatus 100, a live view image immediately before shooting of the original image and a shooting ID which is identification information of the shooting instruction of the original image in response to transmitting the shooting instruction to the image capture apparatus 100, and stores the live view image and the shooting ID in the volatile memory 303 in association with each other. The image capture apparatus 100 can identify the original image corresponding to the shooting ID notified from the control apparatus 200 from the shooting ID associated with the live view image. The image capture apparatus 100 sequentially transmits the live view image to the control apparatus 200, and when receiving the notification of the shooting ID associated with the live view image selected as the transfer target from the control apparatus 200, transfers the original image corresponding to the notified shooting ID to the image management apparatus 250 in preference to other original images among the original images stored in the image capture apparatus 100.

In step S400, the control unit 301 is connected to the image capture apparatus 100. In the present embodiment, the control unit 301 transmits a shooting instruction for requesting start of shooting of a still image, start or end of shooting of a moving image, or a file operation instruction for requesting file operation of an original image to the image capture apparatus 100 via the network 50 by the communication unit 110, and receives a response from the image capture apparatus 100, thereby establishing connection with the image capture apparatus 100.

In step S401, the control unit 301 receives the live view image from the image capture apparatus 100 by the communication unit 310.

In step S402, the control unit 301 displays the live view image received in step S401 on the display unit 309. The control unit 301 updates the live view image displayed on the display unit 309 to the live view image received from the image capture apparatus 100 in step S401.

In step S403, the control unit 301 accepts a user operation by the operation unit 308.

In step S404, the control unit 301 determines whether or not the user operation accepted in step S403 is a display of a list of live view images stored in step S406 described later. Upon determining that the user operation accepted in step S403 is the display of a list of live view images, the control unit 301 proceeds the processing to step S408. Upon determining that the user operation accepted in step S403 is not the display of a list of live view images, the control unit 301 proceeds the processing to step S405.

In step S405, the control unit 301 determines whether or not the user operation accepted in step S403 is a shooting instruction. Upon determining that the user operation accepted in step S403 is the shooting instruction, the control unit 301 proceeds the processing to step S406. Upon determining that the user operation accepted in step S403 is not the shooting instruction, the control unit 301 proceeds the processing to step S411.

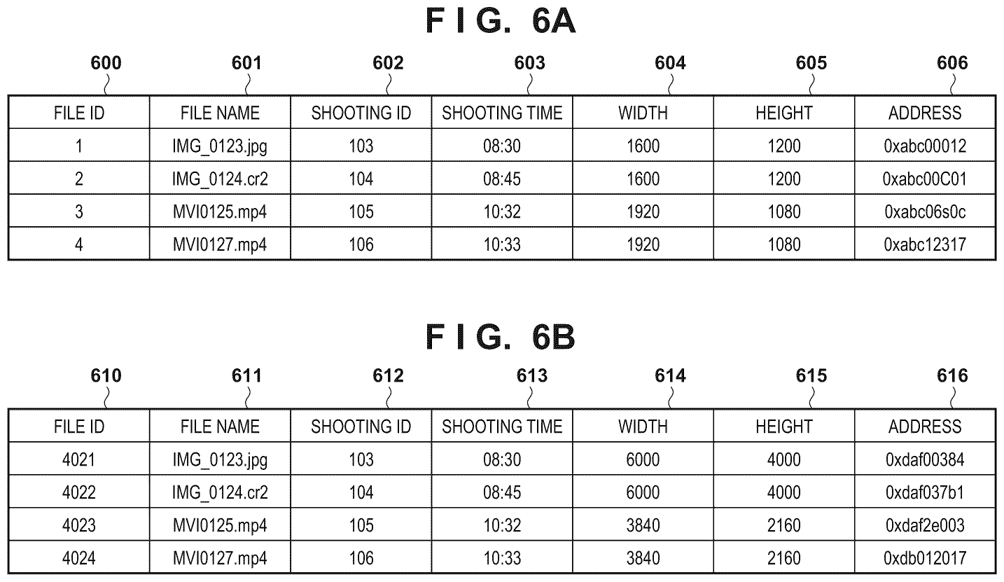

In step S406, the control unit 301 stores the live view image (the live view image immediately before the shooting instruction) displayed on the display unit 309 at the time point when the shooting instruction is received in step S405 and the shooting ID corresponding to the shooting instruction in the volatile memory 303 (FIG. 6A).

In step S407, the control unit 301 transmits the data including the shooting ID and the shooting instruction stored in step S406 to the image capture apparatus 100 by the communication unit 310.

In step S408, the control unit 301 displays a list of the live view images stored in step S406 on the display unit 309.

In step S409, the control unit 301 accepts a user operation of selecting any live view image from the list of live view images displayed on the display unit 309 via the operation unit 308.

In step S410, the control unit 301 causes the communication unit 310 to transmit, to the image capture apparatus 100, data including the shooting ID and the file operation instruction stored in step S406 associated with the live view image selected in step S409. The file operation is transfer or editing of the original image stored in the image capture apparatus 100. For example, in a case where the file operation is the priority transfer, the image capture apparatus 100 transfers the original image corresponding to the shooting ID transmitted to the image capture apparatus 100 in step S410 to the image management apparatus 250 in preference to other original images.

In step S411, the control unit 301 determines whether or not to end the remote control (shooting of image or operation of file) of the image capture apparatus 100. For example, in a case where the connection with the image capture apparatus 100 established in step S400 is disconnected, the control unit 301 determines to end the remote control of the image capture apparatus 100. Upon determining to end the remote control of the image capture apparatus 100, the control unit 301 proceeds the processing to step S412. Upon determining not to end the remote control of the image capture apparatus 100, the control unit 301 returns the processing to step S401.

In step S412, the control unit 301 discards the live view image and the shooting ID stored in step S406, and ends the processing.

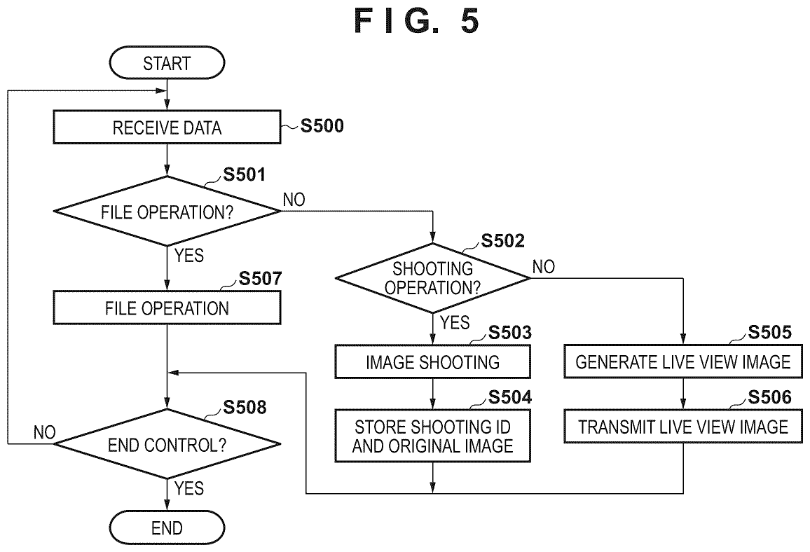

FIG. 5 is a flowchart illustrating control processing of the image capture apparatus 100 of the first embodiment.

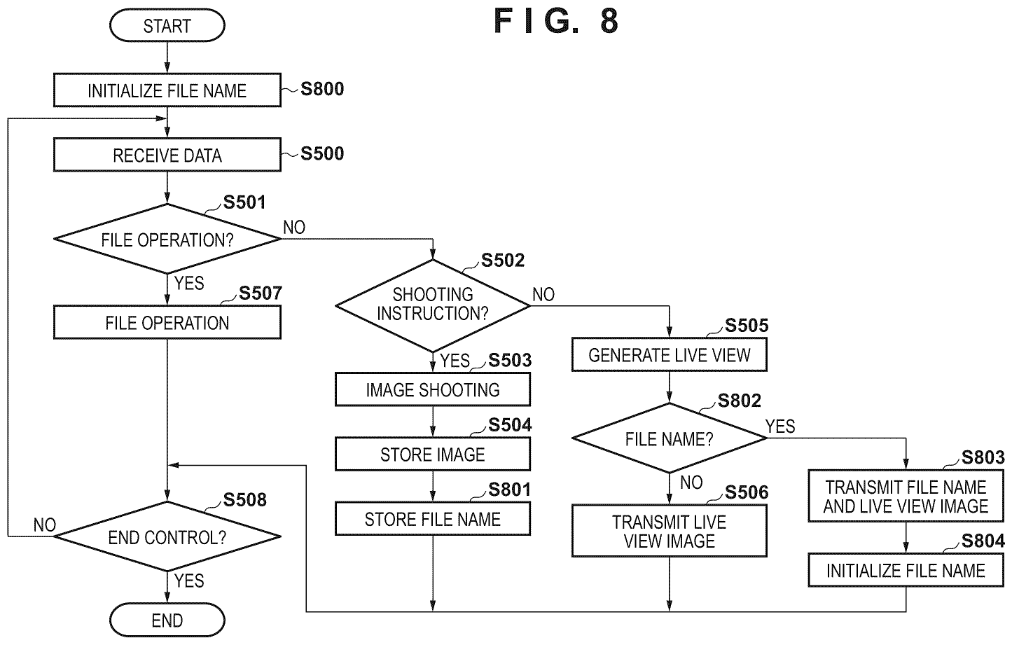

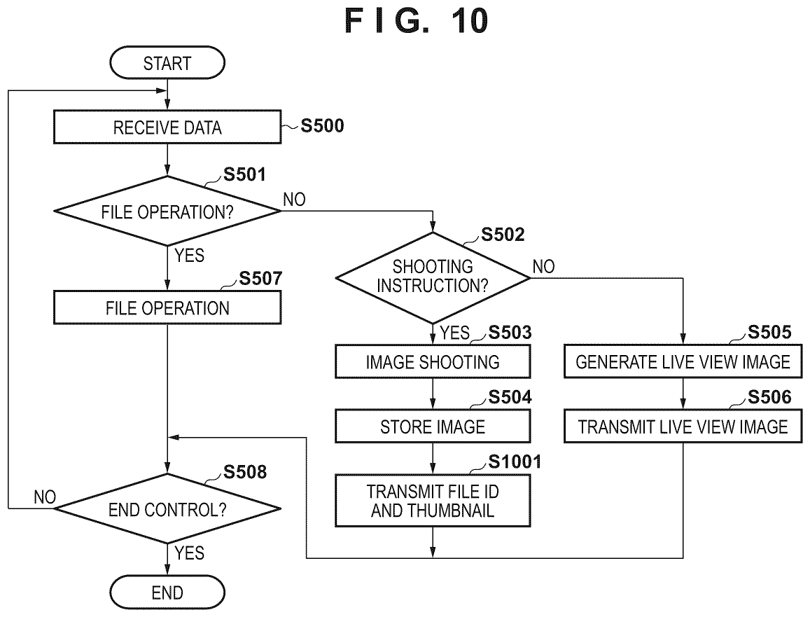

The processing of FIG. 5 is realized by the control unit 101 loading a program stored in the non-volatile memory 102 into the volatile memory 103 and executing the program to control each component of the image capture apparatus 100. The same applies to FIGS. 8 and 10 described later.

In step S500, the control unit 101 receives data from the control apparatus 200 via the network 50 by the communication unit 110. The data received here is data including a shooting instruction or a file operation instruction received from the control apparatus 200, or an image capturing instruction of a live view image periodically received from a system timer.

In step S501, the control unit 101 determines whether or not the data received in step S500 includes a file operation instruction. Upon determining that the data received in step S500 includes the file operation instruction, the control unit 101 proceeds the processing to step S507. Upon determining that the data received in step S500 does not include the file operation instruction, the control unit 101 proceeds the processing to step S502.

In step S502, the control unit 101 determines whether or not the data received in step S500 includes a shooting instruction. Upon determining that the data received in step S500 includes the shooting instruction, the control unit 101 proceeds the processing to step S503. Upon determining that the data received in step S500 does not include the shooting instruction, the control unit 101 proceeds the processing to step S505.

In step S503, the control unit 101 performs shooting of the original image.

In step S504, the control unit 101 stores the shooting ID received in step S500 and the original image shot in step S503 in the recording medium 111 in association with each other (FIG. 6B).

In step S505, the control unit 101 captures a live view image in accordance with an image capturing instruction of the live view image periodically received from the system timer.

In step S506, the control unit 101 transmits the live view image captured in step S506 to the control apparatus 200 via the network 50 by the communication unit 110.

In step S507, the control unit 101 performs the file operation of the original image corresponding to the file operation instruction received in step S500. For example, when the file operation is the priority transfer, the control unit 101 changes the transfer order of the original image stored in the image capture apparatus 100 such that the original image corresponding to the shooting ID received from the control apparatus 200 in step S500 is transferred in preference to other original images, and transfers the original image stored in the image capture apparatus 100 to the image management apparatus 250 according to the transfer order.

In step S508, the control unit 101 determines whether or not to end the remote control (shooting of image or operation of file) by the control apparatus 200. For example, in a case where the connection with the control apparatus 200 established in step 400 is disconnected, the control unit 101 determines to end the remote control of the image capture apparatus 100. Upon determining to end the remote control by the control apparatus 200, the control unit 101 ends the processing. Upon determining not to end the remote control by the control apparatus 200, the control unit 101 returns the processing to step S500.

FIGS. 6A and 6B illustrate a list of image files stored in the control apparatus 200 and the image capture apparatus 100. In FIGS. 6A and 6B, each row indicates one image, and each column indicates information associated with the image.

FIG. 6A illustrates a list of live view images stored in the control apparatus 200.

The file ID 600 is identification information that can uniquely specify a live view image. The file name 601 is the name of the original image associated with the live view image. The shooting ID 602 is information that can specify a shooting instruction corresponding to the original image. The time 603 is information indicating the shooting time of the original image. A width 604 is the width of the live view image. The height 605 is the height of the live view image. The address 606 is an address of a storage area where the live view image is stored.

FIG. 6B illustrates a list of original images stored in image capture apparatus 100.

The file ID 610 is identification information that can uniquely identify the original image. The file name 611 is a name of the original image. The shooting ID 612 is information that can specify a shooting instruction of the original image. The time 613 is information indicating the shooting time of the original image. The width 614 is a width of the original image. The height 615 is the height of the original image. The address 606 is an address of a storage area where the original image is stored.

Note that, in FIGS. 6A to 6B, shooting ID 602 and 612 are information used in the first embodiment. The file names 601 and 611 are information used in the second embodiment. The file ID 600 and 610 are information used in the third embodiment. In the third embodiment, the live view image in FIG. 6A is replaced with a thumbnail image.

As described above, according to the first embodiment, the amount of communication data in the network 50 can be reduced. Furthermore, a live view image immediately before shooting of the original image stored in the image capture apparatus 100 can be browsed or selected by the control apparatus 200, and a file operation of the original image stored in the image capture apparatus 100 associated with the selected live view image can be performed.

Note that, although the live view image captured by the image capture apparatus 100 is sequentially transmitted to the control apparatus 200 in step S506 of FIG. 5, the live view image may be transmitted by live streaming, and the live view image in which the live stream image is decoded by the control apparatus 200 and the shooting ID may be stored in the volatile memory 103 in step S406 of FIG. 4.

### Second Embodiment

Next, control processing of the image capture apparatus 100 and the control apparatus 200 according to the second embodiment will be described with reference to FIGS. 7 and 8.

In the second embodiment, in a case where the live view image sequentially transmitted from the image capture apparatus 100 is displayed on the display unit 309, the control apparatus 200 receives the live view image immediately after the shooting of the original image and the file name of the original image from the image capture apparatus 100 in accordance with the transmission of the shooting instruction to the image capture apparatus 100, and stores the live view image and the file name in association with each other. The image capture apparatus 100 can identify the original image associated with the file name notified from the control apparatus 200 from the file name associated with the live view image. The image capture apparatus 100 sequentially transmits the live view image to the control apparatus 200, and in a case where a notification of the file name of the original image associated with the live view image selected as the transfer target is received from the control apparatus 200, transfers the original image corresponding to the file name among the original images stored in the image capture apparatus 100 to the image management apparatus 250 in preference to other original image.

FIG. 7 is a flowchart illustrating control processing of the control apparatus 200 of the second embodiment.

Note that, in FIG. 7, processing similar to those in FIG. 4 are denoted by the same step numbers, and redundant description is omitted.

In addition, the configurations of the image capture apparatus 100, the control apparatus 200, and the image management apparatus 250 of the second embodiment are similar to the configurations described in FIGS. 1 to 3 of the first embodiment.

In step S700, the control unit 301 determines whether or not the data received in step S401 includes the file name of the original image. Upon determining that the data received in step S401 does not include the file name of the original image, the control unit 301 proceeds the processing to step S701. Upon determining that the data received in step S401 does not include the file name of the original image, the control unit 301 proceeds the processing to step S402.

In step S701, the control unit 301 stores the file name and the live view image received in step S401 in the volatile memory 303 (FIG. 6A).

In step S702, the control unit 301 causes the communication unit 310 to transmit the file name and the file operation instruction stored in step S701 to the image capture apparatus 100.

FIG. 8 is a flowchart illustrating control processing of the image capture apparatus 100 of the second embodiment.

Note that, in FIG. 8, processing similar to those in FIG. 5 are denoted by the same step numbers, and redundant description is omitted.

In step S800, the control unit 101 initializes the file name stored in the volatile memory 103 to be empty.

In step S801, the control unit 101 stores the file name of the original image stored in step S504 in the volatile memory 103 (FIG. 6B).

In step S802, the control unit 101 determines whether or not the file name stored in the volatile memory 103 is empty. Upon determining that the file name stored in the volatile memory 103 is empty, the control unit 101 proceeds the processing to step S803. Upon determining that the file name stored in the volatile memory 103 is not empty, the control unit 101 proceeds the processing to step S506.

In step S803, the control unit 101 causes the communication unit 110 to transmit the file name and the live view image stored in step S801 to the control apparatus 200.

In step S804, the control unit 101 initializes a file name to be stored in the volatile memory 103 to be empty.

As described above, according to the second embodiment, the amount of communication data in the network 50 can be reduced. Furthermore, a live view image immediately after shooting of the original image stored in the image capture apparatus 100 can be browsed or selected by the control apparatus 200, and a file operation of the original image stored in the image capture apparatus 100 associated with the selected live view image can be performed.

Note that, although the live view image captured by the image capture apparatus 100 is sequentially transmitted to the control apparatus 200 in step S803 of FIG. 8, the live view image may be transmitted by live streaming, and the live view image in which the live stream image is decoded by the control apparatus 200 and the shooting ID may be stored in the volatile memory 103 in step S701 of FIG. 7.

### Third Embodiment

Next, control processing of the image capture apparatus 100 and the control apparatus 200 according to a third embodiment will be described with reference to FIGS. 9 and 10. In the third embodiment, when the live view image sequentially transmitted from the image capture apparatus 100 is displayed on the display unit 309, the control apparatus 200 receives the thumbnail image of the original image and the file name of the original image from the image capture apparatus 100 in accordance with the transmission of the shooting instruction to the image capture apparatus 100, and stores the thumbnail image and the file name in the volatile memory 303 in association with each other. The image capture apparatus 100 can identify the original image associated with the file name notified from control apparatus 200 from the file name associated with the thumbnail image. An example will be described in which the image capture apparatus 100 sequentially transmits the live view image to the control apparatus 200, and in a case where a notification of the file name of the original image associated with the thumbnail image selected as the transfer target is received from the control apparatus 200, transfers the original image corresponding to the file name among the original images stored in the image capture apparatus 100 to the image management apparatus 250 in preference to other original images.

FIG. 9 is a flowchart illustrating control processing of the control apparatus 200 of the third embodiment.

Note that, in FIG. 9, processing similar to those in FIG. 4 are denoted by the same step numbers, and redundant description is omitted.

In addition, the configurations of the image capture apparatus 100, the control apparatus 200, and the image management apparatus 250 of the third embodiment are similar to the configurations described in FIGS. 1 to 3 of the first embodiment.

In step S900, the control unit 301 determines whether or not the data received in step S401 includes a thumbnail image. Upon determining that the data received in step S401 includes the thumbnail image, the control unit 301 proceeds the processing to step S901. Upon determining that the data received in step S401 does not include the thumbnail image, the control unit 301 proceeds the processing to step S402.

In step S901, the control unit 301 stores the thumbnail image received in step S401 and the file ID of the original image corresponding to the thumbnail image in the volatile memory 303 (FIG. 6A).

In step S902, the control unit 301 causes the communication unit 310 to transmit the file ID and the file operation instruction stored in step S901 to the image capture apparatus 100.

FIG. 10 is a flowchart illustrating control processing of the image capture apparatus 100 of the third embodiment.

Note that, in FIG. 10, processing similar to those in FIG. 5 are denoted by the same step numbers, and redundant description is omitted.

In step S1001, the control unit 101 causes the communication unit 110 to transmit the thumbnail image of the original image and the file ID of the original image stored in step S504 to the control apparatus 200.

Note that in the third embodiment, the live view image in FIG. 6A may be replaced with a thumbnail image. Furthermore, the file ID 600 of FIG. 6A is equivalent to the file ID 610 of FIG. 6B received from the image capture apparatus 100.

As described above, according to the third embodiment, the amount of communication data in the network 50 can be reduced. In addition, the thumbnail image of the original image stored in the image capture apparatus 100 can be browsed or selected in the control apparatus 200, and the file operation of the original image stored in the image capture apparatus 100 associated with the selected thumbnail image can be performed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-015048, filed Feb. 2, 2024 which is hereby incorporated by reference herein in its entirety.

What is claimed is:

1. A control apparatus comprising:
a communication unit that communicates with an image capture apparatus;
a transmission unit that transmits a control instruction to the image capture apparatus;
a reception unit that receives, from the image capture apparatus, a second image in which data amount is smaller than that of a first image shot by the image capture apparatus;
a display unit that displays a list of the second images received from the image capture apparatus; and
a control unit that notifies the image capture apparatus of the second image selected from the list.

2. The control apparatus according to claim 1, further comprising
a storage unit that stores the second image received from the image capture apparatus when the control instruction is transmitted.

3. The control apparatus according to claim 2, further comprising:
an imaging unit that captures an image; wherein
the reception unit receives a live view image generated by the imaging unit from the image capture apparatus,
the display unit displays the live view image received from the image capture apparatus, and
the control unit updates the live view image displayed on the display unit to the live view image received from the image capture apparatus.

4. The control apparatus according to claim 3, wherein
the second image is the live view image,
the control instruction is a shooting instruction of an image, and
the storage unit stores identification information of the shooting instruction transmitted to the image capture apparatus and the live view image immediately before transmission of the shooting instruction.

5. The control apparatus according to claim 3, wherein
the second image is the live view image,
the control instruction is a shooting instruction of an image, and
the storage unit stores a file name of the first image shot by the image capture apparatus in response to the shooting instruction and the live view image immediately after transmission of the shooting instruction.

6. The control apparatus according to claim 3, wherein
the second image is a thumbnail image,
the control instruction is a shooting instruction of an image, and
the storage unit stores identification information of the first image shot by the image capture apparatus in response to the shooting instruction and a thumbnail image generated from the first image.

7. The control apparatus according to claim 4, wherein
the control unit discards the second image stored in the storage unit when ending the control of the image capture apparatus.

8. The control apparatus according to claim 1, wherein
the second image includes a moving image or a still image.

9. An image capture apparatus comprising:
a communication unit that communicates with a control apparatus;
a reception unit that receives a control instruction from the control apparatus;
a transmission unit that transmits, to the control apparatus, a second image in which a data amount is smaller than that of a first image shot by the image capture apparatus;
a storage unit that stores the first image shot in response to the control instruction; and
a control unit that executes, in response to receiving a notification of the second image from the control apparatus, a predetermined processing related to the first image associated with the notified second image.

10. The image capture apparatus according to claim 9, wherein
the second image is a live view image generated by an imaging unit,
the control instruction is a shooting instruction of an image,
the transmission unit transmits the live view image to the control apparatus, and
the storage unit stores identification information of the shooting instruction received from the control apparatus and the first image shot in response to the shooting instruction.

11. The image capture apparatus according to claim 9, wherein
the second image is a live view image generated by an imaging unit,
the control instruction is a shooting instruction of an image, and
the storage unit stores the first image shot in response to the shooting instruction and a file name of the first image.

12. The image capture apparatus according to claim 9, wherein
the second image is a thumbnail image,
the control instruction is a shooting instruction of an image, and
the storage unit stores the first image shot in response to the shooting instruction and identification information of the first image.

13. The image capture apparatus according to claim 9, wherein
the image capture apparatus is connected to an image management apparatus by the communication unit, and
the predetermined processing is processing of transferring the first image associated with the second image notified from the control apparatus to the image management apparatus.

14. The image capture apparatus according to claim 13, wherein
when the first image to be transferred to the image management apparatus is in plurals, the control unit performs control so that the first image associated with the second image notified from the control apparatus is preferentially transferred.

15. The image capture apparatus according to claim 14, wherein
the control instruction is a transfer instruction of an image, and
the control unit performs control so as to preferentially transfer the first image associated with the second image notified from the control apparatus when receiving a transfer instruction of the image from the control apparatus.

16. The image capture apparatus according to claim 9, wherein
the second image includes a moving image or a still image.

17. A control method of a control apparatus comprising:
connecting with an image capture apparatus so as to be capable of mutual communication;
transmitting a control instruction to the image capture apparatus;
receiving, from the image capture apparatus, a second image in which data amount smaller than that of a first image shot by the image capture apparatus;
displaying a list of the second images received from the image capture apparatus; and
notifying the image capture apparatus of the second image selected from the list.

18. A control method of an image capture apparatus comprising:
connecting with a control apparatus so as to be capable of mutual communication;
receiving a control indication from the control apparatus;
transmitting, to the control apparatus, a second image in which data amount smaller than that of a first image shot by the image capture apparatus;
storing the first image shot in response to the control instruction; and
executing, in response to receiving a notification of the second image from the control apparatus. a predetermined processing related to the first image associated with the notified second image.

19. A non-transitory computer-readable storage medium storing a program for causing a computer to function as a control apparatus comprising:
a communication unit that communicates with an image capture apparatus;
a transmission unit that transmits a control instruction to the image capture apparatus;
a reception unit that receives, from the image capture apparatus, a second image in which data amount is smaller than that of a first image shot by the image capture apparatus;
a display unit that displays a list of the second images received from the image capture apparatus; and
a control unit that notifies the image capture apparatus of the second image selected from the list.

20. A non-transitory computer-readable storage medium storing a program for causing a computer to function as an image capture apparatus comprising:
a communication unit that communicates with a control apparatus;
a reception unit that receives a control instruction from the control apparatus;
a transmission unit that transmits, to the control apparatus, a second image in which a data amount is smaller than that of a first image shot by the image capture apparatus;
a storage unit that stores the first image shot in response to the control instruction; and
a control unit that executes, in response to receiving a notification of the second image from the control apparatus, a predetermined processing related to the first image associated with the notified second image.
